(19) United States
(12) Patent Application Publication
(10) Pub. No.: US 2026/0338256 A1
(43) Pub. Date: Oct. 29, 2026

(54) Method for post-machining vulcanized power transmission belts, and such power transmission belts

(71) Applicant: ARNTZ BETEILIGUNGS GMBH & CO. KG, Höxter (DE)

(72) Inventors: Rudolf OHLHAEUSER, Nieheim (DE); Michael SCHAEPER, Paderborn (DE)

(21) Appl. No.: 19/555,288

(22) Filed: Mar. 3, 2026

(30) Foreign Application Priority Data
Mar. 7, 2025 (DE) 10 2025 108 695.8

(51) Int. Cl. F16G 5/06; B08B 1/00; F16G 1/08; F16G 1/28

(52) U.S. Cl. CPC F16G 5/06; B08B 1/00; F16G 1/08; F16G 1/28

(57) ABSTRACT

The invention relates to a method for post-machining vulcanized power transmission belts, wherein a subtraction of vulcanization products on the surface takes place on at least one side of the power transmission belt. Disclosed in a further aspect are correspondingly available, post-machined vulcanized power transmission belts, in particular V-belts or power belts. Finally, the present invention describes the use of the power transmission belts machined according to the invention in the field of clutch belts.

The invention relates to a method for post-machining vulcanized power transmission belts, wherein a subtraction of vulcanization products on the surface takes place on at least one side of the power transmission belt. Disclosed in a further aspect are correspondingly available, post-machined vulcanized power transmission belts, in particular V-belts or power belts. Finally, the present invention describes the use of the power transmission belts machined according to the invention in the field of clutch belts.

### PRIOR ART

Power transmission belts or drive belts are used in a variety of belt drives, for example in the form of V-belts, timing belts or other types of friction belts. Various aspects of power transmission must be taken into account. In addition to the wear of the drive belts, the coefficient of friction and its reduction play an important role in the transmission of power. High coefficients of friction, also expressed as frictional coefficient or friction coefficient, increase the efficiency of the belt drive due to internal and external friction when transmitting torque. Especially in the field of V-belts and power belts as drive belts, the coefficients of friction and their reduction play an important role, here in special applications such as clutch belts.

The transmission of the drive force or driven force between a pulley and a drive belt or power transmission belt, these two terms are used synonymously hereunder, can take place by way of a form-fit and/or by static friction and/or dynamic friction. When the force is transmitted by static friction between the power transmission zone and a lateral surface of a pulley, the power transmission zone may be flat, such as with flat belts, having a rib structure which is consistent in the running direction and in the cross-sectional profile, as in V-ribbed belts, or having a trapezoidal cross section which is consistent in the running direction cross-sectional profile, such as in V-ribbed belts.

V-belts have, inter alia, a woven fabric casing, in most instances a woven textile fabric. These woven fabrics, also known as textile coatings, are used to improve the transmission of power between the power transmission belt and the power transmission pulleys. Moreover, they allow a reduction in abrasion, a reduction in the tendency to crack, an increase in wear resistance, or else an improvement in the coefficients of friction. This is especially true in the field of clutch belts and other belts with special functions.

Such woven fabrics are applied to the belt body of the drive belts using various techniques. A good connection between the belt body and the woven fabric is important in this context. For this purpose, for example, adhesion promoters and vulcanizable polymer mixtures can applied to the woven fabric on one side in order to connect the woven fabric to the belt body. Here, however, the problem often occurs that the corresponding polymer or the adhesion promoter penetrates through the mesh structure of the woven fabric and thus is present on the outer surface, which negatively affects the properties of the belts, e.g. the coefficient of friction. The coating of the woven fabrics with the corresponding polymer mixtures, e.g. of chloroprene mixtures for producing these semi-coated woven fabrics is generally carried out by means of coating methods or friction methods. In the coating method, a one-sided barrier layer is produced in complex steps, to which non-vulcanized chloroprene-polymer mixtures are then applied for adhesion. In the alternative friction method, the mixture is incorporated with the aid of a calender, for example. In this case, however, the mixture usually forces its way through the mesh structure of the woven fabric in such a manner that coating takes place on both sides, which is not always desirable. As a result, the mixture is also present on the outer surface of the subsequently produced power transmission belt.

Various solutions have been proposed to prevent the presence of these vulcanizates or vulcanization products on the outer surface of the woven fabric, usually by modifying the corresponding mixtures or by forming barrier layers.

It is therefore desirable to provide power transmission belts whose friction coefficients are low, with low abrasion of the textile application, so that wear and frictional resistance are reduced.

This object is achieved by a method of the type mentioned at the outset in such a way that a vulcanized power transmission belt is post-machined in such a manner that vulcanization product on the surface is subtracted on at least one side of the power transmission belt. These vulcanization products present on the surface are in particular a vulcanization skin which is created as part of the vulcanization process. The vulcanization skin is formed on the surface of the drive belts during the vulcanization process. It has now been demonstrated that subtracting these vulcanization products, such as the vulcanization skin, allows a reduction in the coefficient of friction. In addition, it is desirable that further components of the mixture are removed from the woven fabric mesh structure.

It has been demonstrated that the coefficient of friction can be reduced by simply subtracting the material of the vulcanization product on the surface, especially without compromising other parameters of the power transmission belt.

In one embodiment, the surface vulcanization product to be subtracted is the vulcanization skin formed during the vulcanization process.

According to an advantageous design embodiment of the invention, it is provided that the subtraction of vulcanization product takes place on at least one power transmission face, preferably of one or of both mutually averted lateral faces as power transmission faces of a power transmission belt.

In addition, the subtraction of material can also take place on the belt base. Usually, subtraction on the belt back is not required because the belt back is not utilized for transmitting torque. However, subtraction allows an improved belt marking capability of the belt on the belt back.

According to an advantageous design embodiment of the invention, it is provided that the power transmission belt has a woven fabric, in particular a woven textile fabric. The woven fabric, such as the woven textile fabric, at least partially encases the belt body. Prior to subtraction, the vulcanization product to be subtracted is to be found on the outer surface of the woven fabric, i.e., in the case of woven fabric, such as woven textile fabric, it is usually a vulcanized mixture, also referred to as friction mixture, e.g. a mixture that forms the belt body, or the adhesion promoter, and has penetrated the woven fabric.

Subtraction of these vulcanization products from the woven fabric leads to an at least partially exposed woven fabric, so that the woven fabric is present without being encased by the vulcanization product on the outer surface, thus being in contact with the corresponding drive and driven pulleys of a belt drive.

It has been demonstrated that these vulcanization products, the friction mixture, especially the vulcanization skin, present on the outer surface negatively influence the coefficient of friction.

The post-machining of the vulcanized power transmission belts according to the invention, by subtracting the vulcanization products on the surface, overcomes this issue.

This subtraction of material can be carried out according to known methods. A particularly suitable method is an at least partial grinding of the vulcanization products, such as the vulcanization skin, on at least one of the power transmission faces, such as at least one of the lateral faces of the power transmission belt. This allows the friction coefficients to be reduced and the advantageous properties of the woven fabrics present to be used. The subtraction can also take place by brushing these vulcanization products using suitable means.

In an advantageous design embodiment of the invention, the power transmission belt is a V-belt or a belt band with corresponding V-belt elements.

The V-belts usually have a substantially complete casing with a woven textile fabric; accordingly, the method for post-machining according to the invention is directed in particular toward post-machining vulcanized V-belts, so as to remove the vulcanization skin at least partially, e.g. by grinding or brushing, at least on the lateral faces of the V-belts.

In a further design embodiment of the method according to the invention, this is directed toward a, wherein the power transmission belt is a V-belt, wherein this V-belt is designed with an encasing woven fabric, in particular woven textile fabric, and wherein this woven fabric is at least partially exposed in the surface by subtracting vulcanization products. This reduces the coefficient of friction of these drive belts, increases the service life due to the presence of the textile application, while improving noise and smoothness. In another embodiment, the power transmission belt is a clutch belt. The method according to the invention is also particularly suitable for machining power transmission belts with special functions and special applications.

In a further aspect, a vulcanized power transmission belt is also provided. This vulcanized power transmission belt is obtainable according to the method according to the invention. The power transmission belt is distinguished in that the vulcanization product has been at least partially subtracted at least on one side, in particular on the lateral faces. In particular, this subtraction has taken place by grinding. The vulcanized power transmission belt is in a preferred embodiment a V-belt or a power belt consisting of a plurality of V-belts. The V-belts according to the invention, obtainable by the method according to the invention, are designed in such a manner that the woven fabrics encasing the belt body, in particular in the form of the woven textile fabric, are present on the surface due to the subtraction of material, so that these woven fabrics come into contact directly with the surface of the pulley in order to transmit a corresponding torque.

Any customary or suitable textile materials for belt textiles can presently be used as the woven fabric, in particular woven textile fabric. Suitable forms of textiles are woven fabrics, circular or flat knitted fabrics, or nonwovens, such as known to the person skilled in the art also in terms of the qualities, textile materials or threads and/or fiber material, fiber strengths, woven fabric densities, weave/knit patterns and area weights which are used. In one embodiment, the textile material is one selected from cotton, polyamide, polyester, aramid, or a polyester-cotton blend. These materials can also be used in combination.

In terms of textile technology, the woven fabric application is a textile planar structure consisting of a warp and weft thread system with corresponding warp threads for the warp thread system, and weft threads for the weft thread system. The textile materials are common, commercially available textile materials, whereby such woven fabrics are used as standard in which the proportion of warp thread mass is always greater than the proportion of weft thread mass; alternatively, however, the proportion of weft thread mass may also be greater than the proportion of warp thread mass. There are also woven fabrics in which the thread count is identical. This means that known textile materials which are also already used for drive belts, including timing belts, V-belts and V-ribbed belts, can be used.

The drive belt can also be in the form of a wide V-belt or narrow V-belt.

Belts according to the invention are particularly suitable in the field of mechanical engineering, where a comparatively high power transmission is desired. This applies in particular to narrow V-belts, e.g. those of the common sizes SPZ, SPA, SPB and SPC. Other sectors for which the power transmission belts produced according to the invention are particularly suitable include: Belts with special functions and special applications, such as clutch belts. Clutch belts are usually made of low-friction special woven fabrics and, inter alia, a clutch woven fabric, and are specially developed for machines with a clutch function, which are tensioned by means of back tension idlers. The outer woven fabric ensures silent clutch engagement and increased wear resistance. Furthermore, a high strength and a very good resistance to shock loads is necessary. Such belts are used, for example, in garden and park maintenance, such as in ride-on lawnmowers and rotary hoes. For these machines, the requirements for power transmission depend heavily on the respective application. These V-belts can also be used as “problem solvers” for industrial drives.

The invention will be explained in more detail hereunder by means of exemplary embodiments while using drawings.

In the drawings:

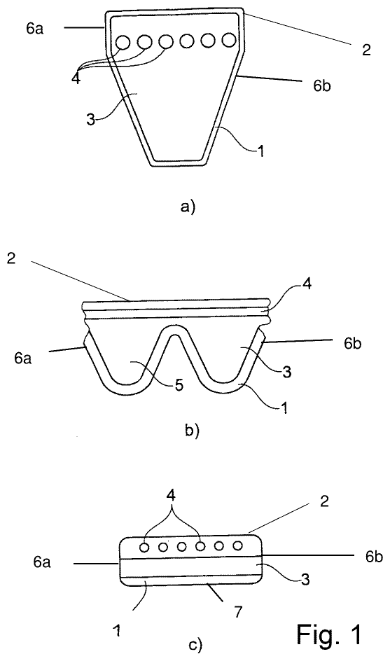

FIG. 1 shows power transmission belts as standard belts for the corresponding post-machining of the surfaces.

FIG. 1a shows a V-belt with a complete textile casing 1. Also illustrated are the power transmission zone 3, which is encased by the textile 1, and the strength members 4 as well as the belt back 2. Here, the post-machining of the belt according to the invention usually takes place at least on the lateral faces 6a and 6b.

FIG. 1b shows a timing belt with the teeth 5 disposed in the transverse direction, and longitudinally running strength members 4, and the power transmission zone 3 and the belt back 2. The post-machined face preferably comprises the textile material 1 on the power transmission zone 3, and presently the lateral faces 6a and 6b.

FIG. 1c shows a flat belt, the textile support 1 of which rests on the power transmission zone 3 and is post-machined according to the invention. Further post-machining can also be carried out on the lateral faces 6a, 6b and also on the belt base 7. Also illustrated are the strength members 4 and the belt back 2.

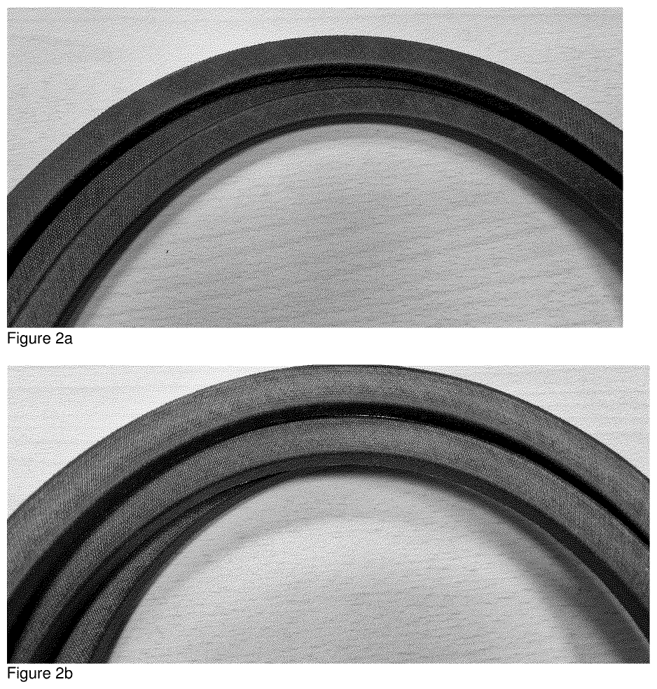

FIG. 2 shows a V-belt according to the invention before (FIG. 2a) and after (FIG. 2b) post-machining.

Clearly to be seen in FIG. 2b in the belt treated according to the invention is the subtraction of vulcanization products on the surface, as compared to the image of FIG. 2a; this subtraction allows a reduction in the coefficients of friction, and thus a reduction of wear on the belt.

### Coefficient of Friction Measurement on Power Transmission Belts

The test was carried out on a tensile testing machine. A belt piece with textile casing is pulled over a profiled pulley (test speed: 1000 mm/min/measuring distance 380 mm/5 measuring cycles), with the upper end of the belt attached to a clamp on a tension cylinder with load cell (10 kN), and a weight (1200 g) suspended from the free-hanging end of the belt. The determined force-displacement diagram results in u as the coefficient of friction. The results for CR-based and EPDM-based belts are illustrated in Table 1. 5 measurements were made per belt and the mean value was determined.

TABLE 1

| | | Calculated coefficients | Mean |
|---|---|---|---|
| Polymer | State | of friction | value |
| CR | New | 0.688\|0.709\|0.718\|0.717\|0.718 | 0.710 |
| CR | Ground | 0.454\|0.439\|0.445\|0.453\|0.456 | 0.449 |
| EPDM | New | 0.821\|0.857\|0.879\|0.894\|0.902 | 0.871 |
| EPDM | Ground | 0.511\|0.496\|0.506\|0.517\|0.526 | 0.511 |

The reduction in the coefficient of friction of belts post-machined according to the invention is clearly visible. This applies to both CR-based and EPDM-based belts.

### REFERENCE SIGNS

1 Textile material
2 Belt back
3 Power transmission zone
4 Strength member
5 Teeth
6, 6a, 6b Lateral faces
7 Belt base

1. A method for post-machining vulcanized power transmission belts, comprising subtracting one or more vulcanization products on a surface of at least one power transmission face of a vulcanized power transmission belt.

2. The method according to claim 1, wherein the one or more vulcanization products comprise a vulcanization skin.

3. The method according to claim 1, wherein the surface is a lateral face of the power transmission belt.

4. The method according to claim 1, wherein a woven fabric at least partially encases a belt body of the vulcanized power transmission belt, and prior to subtraction, the one or more vulcanization products are present on an outer surface of the woven fabric.

5. The method according to claim 1, wherein the subtraction of the one or more vulcanization products takes place on a belt base.

6. The method according to claim 1, wherein the subtraction of the one or more vulcanization products takes place by grinding or brushing.

7. The method according to claim 1, wherein the vulcanized power transmission belt is a V-belt or a belt band.

8. The method according to claim 1, wherein the vulcanized power transmission belt is a V-belt, wherein this V-belt is designed with an encasing woven fabric, and wherein this woven fabric is at least partially exposed on a surface by subtracting vulcanization product.

9. A vulcanized power transmission belt, obtained according to method of claim 1.

10. The vulcanized power transmission belt according to claim 9, wherein the vulcanized power transmission belt is a V-belt.

11. A method of using the vulcanized power transmission belt according to claim 9 as a clutch belt.

12. The method of claim 1 wherein the at least one power transmission face comprises two mutually averted lateral faces of the power transmission belt.

13. The method according to claim 1 wherein the vulcanized power transmission belt is a clutch belt.

14. The method of claim 8 wherein the encasing woven fabric is a woven textile fabric.
